(19) United States
(12) Patent Application Publication
(10) Pub. No.: US 2008/0236183 A1
(43) Pub. Date: Oct. 2, 2008

(54) Refrigerator having photocatalyst

(76) Inventor: Keiji Iimura, Tokyo (JP)

Correspondence Address: KEIJI IIMURA, 10-8, AKATSUKA 3 CHOME, ITABASHIKU, TOKYO, 175-0092, JP

(21) Appl. No.: 12/156,623

(22) Filed: Jun. 4, 2008

(30) Foreign Application Priority Data
Nov. 15, 2005 (JP) 2005-330284

(51) Int. Cl. F25D 23/00; F21V 33/00

(52) U.S. Cl. 62/264; 362/92

(57) ABSTRACT

A refrigerator having photocatalyst comprises: a photocatalytic light guide member, composed of a light guide member and a photocatalyst; the light guide member having a light entrance portion and a light leaking portion; the photocatalyst being composed of visible light responsive photocatalytic material, disposed on or adjacent to the light leaking portion; at least one visible light emitting type light emitting element, for emitting visible light which is directed or incident to the light entrance portion; and wherein the visible light responsive photocatalytic material is excited by visible light which is leaked from the light leaking portion. Thereby, the photocatalyst indicates a photocatalytic decomposition activity and at least a shelf and a store room can be kept clean.

### CROSS-REFERENCE TO RELATED APPLICATIONS

This application is based on the prior Japanese Patent application No. 2005-330284 filed on Nov. 15, 2005 which is published on Jun. 7, 2007 as Japanese Patent Laid-Open No. 2007-139230, and the entire disclosure of which is incorporated herein by reference in its entirety.

### BACKGROUND OF THE INVENTION

1. Field of the Invention

The present invention is related to a refrigerator having a photocatalyst that exhibit an optical antibacterial function.

The present invention is related to a refrigerator having lighting and an optical antibacterial function.

2. Description of the Related Art

A refrigerator is disclosed in the patent documents 1 (Japanese Patent Laid-Open No. 05-039978) as follows.

PURPOSE: To improve the visual workability in a storage room of a refrigerator by providing lighting system which prevents foods from casting shadows on the wall.

CONSTITUTION: A lighting system is composed of a light guide 1, a light source 2, a reflector 3, a shielding plate 4 and a slit 5. Most of the light generated from the light source 2 is reflected and converged on the reflector 3 and transmitted to the light guide 1. Apart of the light leaks out of the vertical slit 5 and evenly lights the wall surface. The light transmitted to the light guide 1 is irregularly reflected on the coated surface and transmitted and diffused. Thus, foods placed below the light guide 1 are evenly lighted. The light leaked out of the slit 5 lights evenly the wall surface so that the storage space looks wide and deep. In this way, a lighting condition superior in visual workability without casting shadows of foods is realized.

An illuminator for refrigerator is disclosed in the patent documents 2 (Japanese Patent Laid-Open No. 09-203582) as follows.

PROBLEM TO BE SOLVED: To fasten the starting of a luminous flux with high efficiency, long life and excellent starting characteristics at a low temperature and to incorporate deodorizing function of long life by attempting to increase the storage space in a refrigerator.

SOLUTION: The illuminator for a refrigerator comprises a bulb with a three band fluorescent layer overlying the inner surface, discharging medium containing rare gas containing xenon as a main body and sealed in the bulb, a fluorescent lamp 17 having a pair of electrodes for generating discharge in the bulb and disposed in a refrigerator body 12, and a light guiding plate 16 having a light emitting surface 15 receiving the light from the lamp 17 from the side end to emit a light in a surface state and opposed in the body 12.

PROBLEM TO BE SOLVED: To reduce power consumption and to illuminate a cold storage chamber and deep freezing chamber irrespective of an amount of food by constituting by a light diverging means provided at an outer surface of a light transmitting means to emit a light transmitted via the transmitting means in a predetermined direction out of the transmitting means.

SOLUTION: An illuminating means 13 comprises a plurality of light diffusing members 23 for distributing a light from a light transmitting means 15 to a predetermined area and connected to a protrusion of the means 15 to perform a role of a shelf, and light diverging means 25 provided at outer surfaces of the members 23 to emit the light distributed in the members 23 in a predetermined direction out of the members 23. An optical fiber has a core for transmitting the light, and a clad for totally reflecting the light of the core. The clad of the fiber is removed so that light introduced into the core is transmitted along the core by total reflection but the light is not emitted to front sides of the members 23.

The illuminator for refrigerator is disclosed in the patent documents 4 (Japanese Patent Laid-Open No. 11-159953) as follows.

PROBLEM TO BE SOLVED: To provide an interior illuminator for refrigerator which does not spoil the freshness of the foodstuffs stored in a refrigerator for a long period.

SOLUTION: An interior illuminator for refrigerator which illuminates the foodstuffs stored in a refrigerator at a low temperature is provided with a mounted board 1 and a plurality of semiconductor light emitting elements 2 which are arranged on the board 1 in parallel with each other and only emits light having a wavelength which falls within a visible light domain between about 420 nm and about 780 nm.

A refrigerator is disclosed in the patent documents 5 (Japanese Patent Laid-Open No. 2001-501295) and the patent documents 6 (U.S. Pat. No. 6,210,013 corresponding to the patent documents 5) as follows.

A refrigerator capable of being internally illuminated wherein the illumination is provided by an edge-lit panel of a substantially transparent material having two opposed surfaces of which at least one is within the refrigerator and on which a matrix of dots is applied so as to produce a light piping effect internally in to the refrigerator and wherein the light source of the edge-lit panel is located within the enclosed space of the refrigerator.

One or more edge-lit panels may be used, which may be shelf of the refrigerator, or its side panels, back panel or roof panel. The edge-lit panel may be form from a transparent acrylic sheet, preferably containing an optical brightener. Protective transparent or translucent layer and a light diffuser may be applied to the surface carrying the matrix of dots.

A visible light responsive photocatalyst is disclosed in the patent documents 7 (Japanese Patent Laid-Open No. 2004-988) and the patent documents 8 (Japanese Patent No. 3,601,532 corresponding to the patent documents 7) as follows.

PROBLEM TO BE SOLVED: To obtain a photocatalytic substance which develops a photocatalytic function by visible light.

SOLUTION: A Ti—O—N film 12, wherein nitrogen is added to titanium oxide crystals by substituting a part of the oxygen site of titanium oxide crystals with a nitrogen atom, is formed on an SiO2 substrate 10. As a result, a chemical bond is present between Ti and N atoms in the crystals and the Ti—O—N film absorbs visible light to develop a photocatalytic function. For example, the thin Ti—O—N film with a thickness of 10 μm or less is formed on the substrate.

Another visible light responsive photocatalyst is disclosed in the patent documents 9 (Japanese Patent Laid-Open No. 2002-239395) and the patent documents 10 (Japanese Patent Laid-Open No. 2004-73910) as follows.

PROBLEM TO BE SOLVED: To provide a photocatalyst excited by the irradiation with visible light and stably developing high photocatalytic activity and a method for manufacturing the photocatalyst industrially, economically and advantageously.

SOLUTION: The photocatalyst is obtained by adding a platinum halide compound to the surfaces of photocatalyst particles comprising titanium oxide or the like. Further, photocatalyst particles and a platinum halide compound are heated in a liquid medium or an accelerator containing hypo-phosphorous acid or the like is further added to the liquid medium at the time of heating to manufacture the photocatalyst.

A still another visible light responsive photocatalyst is disclosed in the patent documents 11 (Japanese Patent Laid-Open No. 2002-239395) and the patent documents 12 (Japanese. Patent Laid-Open No. 2004-73910) as follows.

PROBLEM TO BE SOLVED: To provide a photocatalyst excited by the irradiation with visible light and stably developing high photocatalytic activity and a method for manufacturing the photocatalyst industrially, economically and advantageously.

SOLUTION: The photocatalyst is obtained by adding a platinum halide compound to the surfaces of photocatalyst particles comprising titanium oxide or the like. Further, photocatalyst particles and a platinum halide compound are heated in a liquid medium or an accelerator containing hypo-phosphorous acid or the like is further added to the liquid medium at the time of heating to manufacture the photocatalyst.

A leaky optical fiber is disclosed in the patent documents 13 (Japanese Patent Laid-Open No. 2001-108856) and the patent documents 14 (Japanese Patent Laid-Open No. 2002-202415) as follows.

The patent documents 13 discloses an optical fiber as follows:

PROBLEM TO BE SOLVED: To provide an optical fiber of a flank emission type which has constant quality and can uniformly emit light outside with excellent reproducibility.

SOLUTION: The optical fiber having a core in the central part and a clad which is disposed at the peripheral edge of this core and has a refractive index lower than the refractive index of the core is so constituted that a rugged structure is imparted between the core and the clad along the circumferential and longitudinal directions of the fiber.

The patent documents 14 discloses a side face light emitting optical fiber as follows:

PROBLEM TO BE SOLVED: To provide a side face light emitting optical fiber capable of improving uniformity of side face light emitting luminance over the longitudinal direction even in an optical fiber having a relatively long core length.

SOLUTION: In the side face light emitting optical fiber having a core at the central part and a clad arranged around the core, the clad is composed of a first transparent layer which comes into contact with the core and a second light diffusing layer which is formed in the outside of the first layer, and moreover both layers are integrally formed.

A list of cited documents by the applicant are as follows:

Patent document 1; Japanese Patent Laid-Open No. JPO5-039978,
Patent document 2; Japanese Patent Laid-Open No. JPO9-203582,
Patent document 3; Japanese Patent Laid-Open No. JP10-141845,
Patent document 4; Japanese Patent Laid-Open No. JP11-159953,
Patent document 5; Japanese Patent Laid-Open No. JP2001-501295,
Patent document 6; U.S. Pat. No. 6,210,013,
Patent document 7; Japanese Patent Laid-Open No. JP2004-988,
Patent document 8; Japanese Patent No. JP3601532,
Patent document 9; Japanese Patent Laid-Open No. JP2002-239395,
Patent document 10; Japanese Patent Laid-Open No. JP2004-73910,
Patent document 11; Japanese Patent Laid-Open No. JP2002-239395,
Patent document 12; Japanese Patent Laid-Open No. JP2004-73910,
Patent document 13; Japanese Patent Laid-Open No. JP2001-108856, and
Patent document 14; Japanese Patent Laid-Open No. JP2002-202415,

The patent documents 1 and the patent documents 3 to 6 disclose the lighting in the room (warehouse) of a refrigerator, and are not disclosed about photocatalyst at all.

The patent documents 8 to 12 disclose a visible light response type photocatalyst, and can be used as one component of this invention.

The patent documents 2 (JP 09-203582) discloses a refrigerator having a light guide member of a glass plate, a fluorescent lamp to emit light including ultraviolet (UV) and an UV responsive photocatalyst film disposed on the glass plate.

However, this refrigerator disclosed in the patent documents 2 (JP 09-203582) has following disadvantages based on a use of ultraviolet light:

If a photocatalyst film is coated entirely on the light exit surfaces of the light guide member, it is not restricted that most ultraviolet rays are absorbed by the photocatalyst film, but there is a possibility that some ultraviolet rays may be emitted from the light guide member to the room of the refrigerator.

After long-term of use or frequent contacts with articles housed in the room, the photocatalyst film partially or entirely wears out and exfoliates from the light exit surface of the light guide member and ultraviolet rays exits from an exposed portion of the light exit surface without absorbing in the photocatalyst film to the room.

The light guide member made of polymer or plastic material cannot be used for ultraviolet irradiated device, for instance, a typical transparent polymer or plastic material of acryl resin (PMMA) or polycarbonate resin (PC) is easy to decompose or tint to e.g. yellow color due to long-term of irradiation of ultraviolet light. Therefore, the patent documents 2 discloses to use a glass plate as the light guide member.

If the articles, typically foodstuffs stored in the room of the refrigerator receives ultraviolet rays leaked from the light exit surface of the light guide member, the articles may be decomposed.

In this refrigerator disclosed in the patent documents 2, the light guide member with the photocatalyst film and the fluorescent lamp to emit light containing visible light and UV light is used in lighting and an antibacterial function, therefore users may receive UV light leaked from the light guide member at the times of opening/closing the door of the refrigerator and that may give a bad influence by the ultraviolet rays to human body such as eyes.

### BRIEF SUMMARY OF THE INVENTION

A major purpose of the present invention is to eliminate the disadvantages of the prior art described hereinbefore.

A first aspect of the present invention is a refrigerator which comprises: 1) a photocatalytic light guide member, composed of light guide member and a photocatalyst; the light guide member having a light entrance portion and a light leaking portion, 2) the photocatalyst being composed of visible light responsive photocatalytic material, disposed on or adjacent to the light leaking portion; 3) at least one visible light emitting type light emitting element, for emitting visible light which is directed or incident to the light entrance portion; and 4) wherein the visible light responsive photocatalytic material is excited by visible light which is leaked from the light leaking portion.

A second aspect of the present invention is a refrigerator which comprises: 1) a photocatalytic light guide member, composed of light guide member and a photocatalyst; the light guide member having a light entrance portion and a light leaking portion, 2) the photocatalyst being composed of visible light responsive photocatalytic material, disposed on or adjacent to the light leaking portion; 3) at least one visible light emitting type light emitting element, for emitting visible light which is directed or incident to the light entrance portion; 4) at least one leaky optical fiber disposed in/on or adjacent to the light guide member and 5) wherein the visible light responsive photocatalytic material is excited by visible light which is leaked from the light leaking portion.

### BRIEF DESCRIPTION OF THE SEVERAL VIEWS OF THE DRAWING

For a more complete understanding of the present invention and the advantage thereof, reference is now made to the following descriptions taken in conjunction with the accompanying drawings, in which:

FIG. 1 is a schematic perspective view showing a refrigerator;

FIG. 2 is a schematic enlarged perspective view showing a first embodiment of the invention;

FIG. 3 is a schematic enlarged cross sectional view taken along the line A-A of FIG. 2;

FIG. 4 is a schematic enlarged perspective view showing a second embodiment of the invention;

FIG. 5A is a schematic enlarged cross sectional view taken along the line B-B of FIG. 4;

FIG. 5B is a schematic enlarged cross sectional view taken along the line C-C of FIG. 4;

FIG. 6A, FIG. 6B, FIG. 6C and FIG. 6D are schematic perspective views showing several structures of leaky optical fibers for use in the second embodiments of the invention;

FIG. 7A, FIG. 7B, FIG. 7C and FIG. 7D are schematic perspective views showing several structures of other leaky optical fibers for use in the second embodiments of the invention;

FIG. 8 is a schematic enlarged perspective view showing a third embodiment of the invention;

FIG. 9 is a schematic enlarged perspective view showing a fourth embodiment of the invention; and

FIG. 10 is a schematic enlarged perspective view showing a fifth embodiment of the invention.

### DETAILED DESCRIPTION OF THE INVENTION

At first, visible light responsive photocatalyst and a visible light emitting type light emitting element e.g. light emitting diode (LED) which can be used in several embodiments are explained below.

(Visible Light Responsive Photocatalyst)

Visible light responsive photocatalyst materials which can be used in several embodiments are, for example, the photocatalyst materials disclosed in the patent documents 7 (Japanese Patent Application Publication No. JP2004-988), the patent documents 8(Japanese Patent No. 3601532), the patent documents 9 (Japanese Patent Application Publication No. 2002-239395), the patent documents 10 (Japanese Patent Application Publication No. 2004-73910), the patent documents 11 (Japanese Patent Application Publication No. 2002-239395), the patent documents 12 (Japanese Patent Application Publication No. 2004-73910) and other patent documents.

Visible light responsive photocatalyst materials which can be used for this invention, for example, the following (a), (b) are (c) are commercially available as follows. These photocatalyst materials can be excited by blue light.

(a): Photocatalyst materials are available from Ishihara Sangyo Kaisha, ltd. Japan (brand MPT-621, MPT-623, etc.) which are composed of titanium oxide having platinum compound.

(b): A photocatalyst material was developed by Toyota Central R&D Labs. Japan, which is composed of Nitrogen doped titanium oxide (TiO—N).

(c) Photocatalyst materials are available from Sekisui Jushi Corporation, Japan, which are composed of sulfur-cation doped titanium oxide having iron.

(Visible Light Emitting Type Light Emitting Diode)

Visible light emitting type Light Emitting Diodes (LEDs) which can be used in several embodiments is the LEDs to emit light having a blue wavelength range.

These blue light emitting LEDs use semiconductor tips for emitting mainly blue visible light which are typically composed of gallium nitride (GaN), indium gallium nitride (InGaN) or zinc oxide (ZnO).

As blue visible light emitting type LED, a LED package which is composed of a near-ultraviolet light emitting semiconductor chip (e.g. GaN and InGaN) and a blue phosphor can be used for the invention, in which the blue phosphor receives the near UV light from the semiconductor chip and convert a short wavelength of the near light to a long wavelength of blue light.

For example, the near UV emitting chip is embedded in a transparent resin capsule containing blue phosphor particles or the near UV emitting chip is covered with a lens in which blue phosphor is coated on a top or bottom surface.

Blue light emitting type LEDs suitably used for embodiments of the invention are commercially available from Toyoda Gosei Co., Ltd, Japan, Nichia Chemical Industries, Japan, Lumileds Lighting U.S., LLC, U.S.A., Cree, Inc. U.S.A.

### A FIRST EMBODIMENT OF THE INVENTION

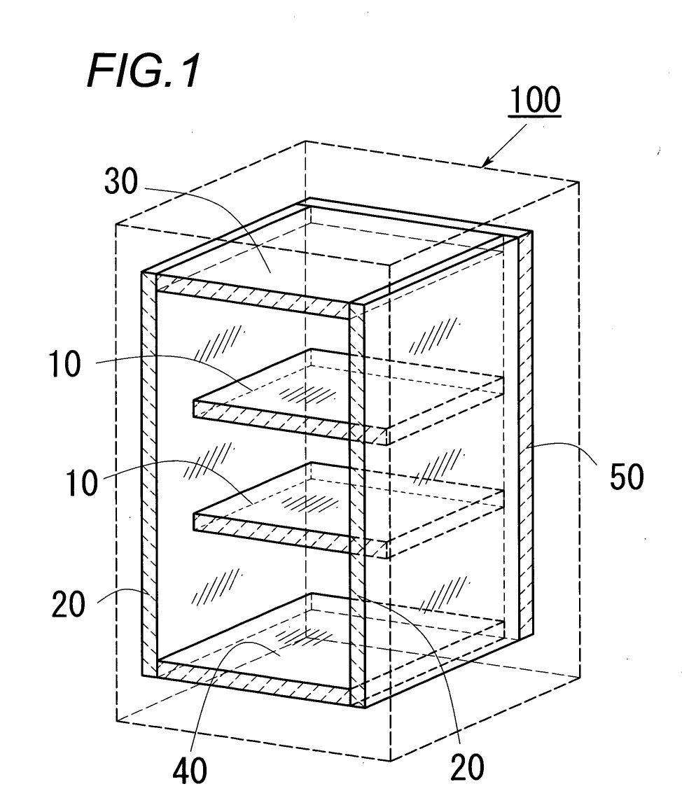

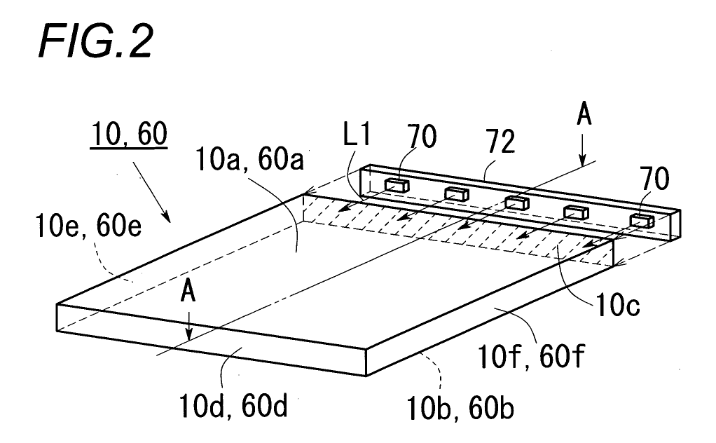

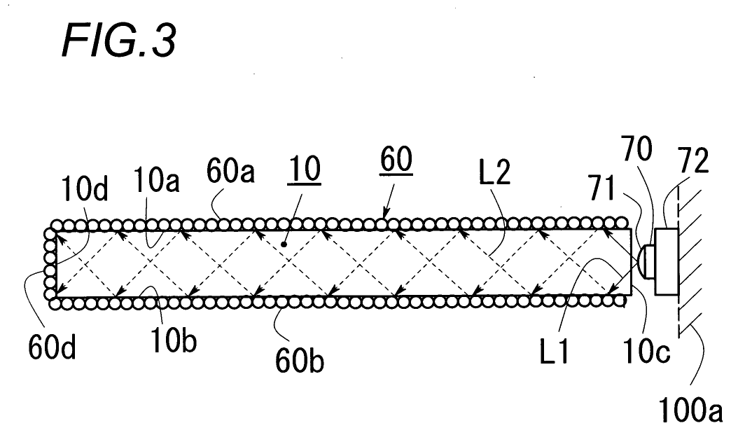

An embodiment of the invention is described referring to FIG. 1, FIG. 2 and FIG. 3.

A refrigerator 100 generally comprises a thermally insulated box and a cooling/freezing device, in which the box is provided with at least one storage room to store typically foodstuffs and the cooling/freezing device is for cooling/freezing the foodstuffs.

The storage room is provided with a top wall (top panel) 30, a bottom wall (bottom panel) 40, a back wall (back panel) 50, left and right side walls (left and right panels) 20 and at least one shelf (shelf plate) 10.

In the first embodiment, the shelf (shelf plate) 10 is composed of a light guide member.

The light guide panel (light guide shelf) 10 is composed of a substantially rectangular light transmissive (transparent or semi-transparent) panel or plate made of a light transmissive synthetic resin or glass.

The light guide shelf 10 may be made of light transmissive synthetic resin materials such as acrylic resin, polycarbonate resin, polypropylene resin, polyethylene terephthalate resin, ABS resin and epoxy resin.

The light guide shelf 10 may be made of light transmissive glass materials such as tempered glass and quartz.

As shown in FIG. 2 and FIG. 3, the light guide shelf 10 is a panel-like sheet-like member composed of a front surface 10a, a rear surface 10b opposed to the front surface 10a, opposed side faces 10c, 10d and opposed side faces 10e, 10f.

A printed-circuit board 72 is arranged at a wall 100a, in which at least one visible light emitting type semiconductor light emitting element, typically Light Emitting Diode (LED) 70 is mounted on the printed-circuit board 72.

Blue light emitting LED/LEDs 70 are suitably used in the invention, in which the LED/LEDs 70 emit light having a blue peak wavelength.

Further, LED/LEDs 70 are preferably used in the invention, in which the LED/LEDs 70 emit light including a blue color and excluding ultraviolet rays (UV).

The visible color LED 70 is positioned adjacent to the light guide shelf 10, in such a manner that a light exit window (or lens) 71 of the visible color LED 70 faces a side face 10c of the light guide shelf 10.

Therefore, light emitting from the light exit window 71 can be directed to the side face 10c which acts as a light entrance portion of the light guide shelf 10.

Instead, at least one optical fiber for light transmission is interposed between the visible color LED 70 and the light guide shelf 10, in which the visible color LED 70 can be positioned at any place in the box or room.

A visible light responsive photocatalyst 60 is carried on at least one portion of the light guide shelf 10, in which the visible light responsive photocatalyst 60 is excited by light including blue color from the visible color LED 70

As shown in FIG. 2 and FIG. 3, visible light responsive photocatalytic films 60 (60a, 60b, 60c, 60d) containing or consisting of the visible light response type photocatalyst may be formed partially or entirely on the front and rear surfaces 10a, 10b and the three sides 10a, 10b, 10d, except for the side face 10c which is the light entrance portion to receive light from the visible color LED 70.

The visible light responsive photocatalytic films 60 (60a, 60b, 60c, 60d) may be composed of a transparent resin film containing a plurality of photocatalyst particles dispersed therein.

The visible light responsive photocatalytic films 60 (60a, 60b, 60c, 60d) may be composed of a plurality of photocatalyst particles, a plurality of light diffusing particles and a transparent resin as a binder containing the photocatalyst particles and light diffusing particles dispersed therein, in which the light diffusing particles may be composed of transparent polymer beads or glass beads which have a refractive index different from transparent resin.

As shown in FIG. 3, visible light L1 emitted from the light exit window 71 of the visible light emitting type LED 70 enters into the side face 10c of the light guide shelf 10, visible light L2 entered in the light guide shelf 10 transmits within the light guide shelf 10 and advances from the side face 10c (light entrance portion) toward the side face 10d opposed to the side face 10c, in such a manner that visible light L reflects repeatedly between the front and rear surfaces 10 a and 10b based on a total internal reflection (TIR).

Light L2 transmitted within the light guide 10 leaks gradually on the way of transmission from the front and rear surfaces 10 a and 10b (and three side faces 10 d, 10e and 10f) to the visible light responsive photocatalytic films 60 (60a, 60b, 60c, 60d).

At that time, the visible light responsive photocatalytic films 60 (60a, 60b, 60c, 60d). absorb light L2 leaked from the light guide 10, so that the photocatalytic films 60 are excited by light L2, thereby the photocatalytic films 60 indicate a photocatalytic decomposition activity.

Therefore, dirt or odor organic components such as bacteria, mold, dirt ingredients of food which are adhered on or contacted with the photocatalyst films 60 (60a, 60b, 60c, 60d) on the light guide shelf 10 are decomposed by the photocatalytic decomposition activity.

Thereby, the light guide shelf 10 and also air circulating in the room of the refrigerator are kept clean, due to the photocatalytic decomposition activity. showing sterilization, disinfection, antibacterial and deodorizing properties.

In the first embodiment of the invention, the photocatalyst film 60 is formed on the shelf 10 of the refrigerator 100, however, the photocatalyst film 60 may be formed on an exposed surface of at least one of the left and right side plates 20, the top plate 30, the bottom plate 40, the rear plate 50 (see FIG. 1) which are composed of the light guide member.

These light guide plates 20, 30, 40 and/or 50 with the photocatalyst 60 are positioned adjacent to walls (left and right side walls, a top wall, a bottom wall and/or a rear wall) of the box of the refrigerator 100.

Instead, the walls (left and right side walls, a top wall, a bottom wall and/or a rear wall) themselves may be composed of the light guide plates 20, 30, 40 and/or 50 with the photocatalyst 60.

### A SECOND EMBODIMENT OF THE INVENTION

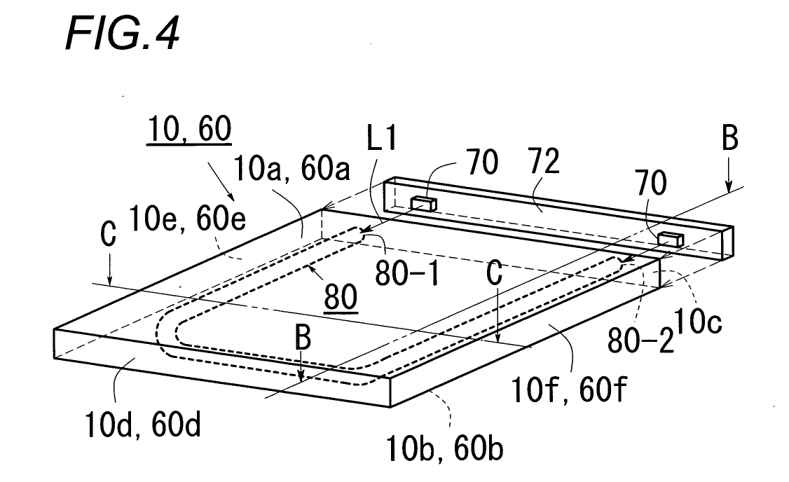

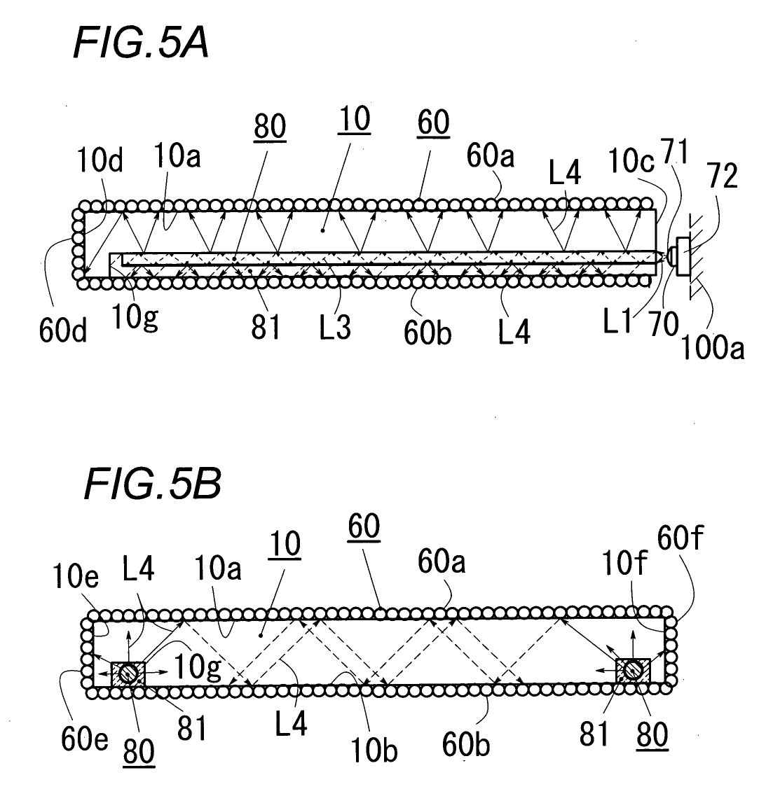

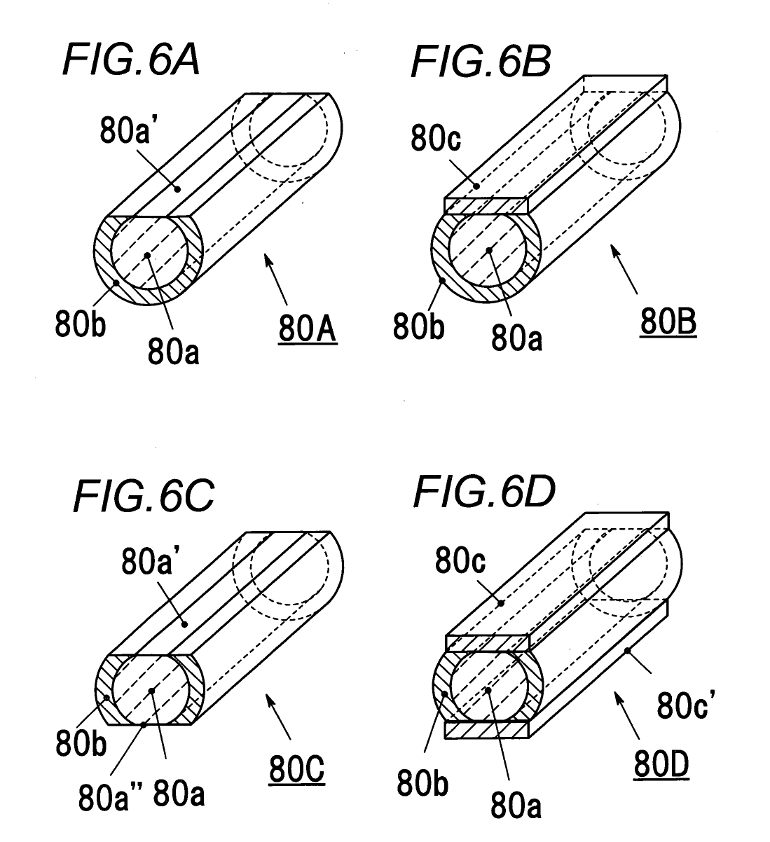

Referring to second embodiment of the invention is described with reference to FIG. 4, FIG. 5A, FIG. 5B and FIG. 6.

A light guide member (e.g. light guide shelf) 10 is composed of a light transmissive plate or panel made of polymer or glass.

As shown in FIG. 4, FIG. 5A and FIG. 5B, the light guide shelf 10 is composed of a substantially rectangular light guide panel or plate having opposed front and rear surfaces 10a, 10b, one set of opposed side faces 10c, 10d and another set of opposed side faces 10e, 10f and visible light responsive photocatalytic films 60 are formed on the front and rear surfaces 10a, 10b and the side faces 10d, 10e and 10d.

In the second embodiment, a leaky optical fiber 80 is provided, which is positioned on/in or adjacent to the light guide shelf 10.

The light guide shelf 10 is provided with a groove (i.e. ditch) 10g in the rear surface 10b, in which the groove 10g may have a shape corresponding to the shape of the leaky optical fiber 80.

As shown in FIG. 4, t FIG. 5A and FIG. 5B, the groove 10g may have a “U” shape and the leaky optical fiber 80 bent to the “U” shape is placed in the groove 10g.

At least one light entrance end of the leaky optical fiber 80 is positioned so as to expose at the side face 10c of the leaky optical fiber 10.

At least one visible color LED 70 mounted on a printed circuit board 72 is positioned at a wall, LED 70 faces to the light entrance end of the leaky optical fiber 80 with a gap, visible light L1 emitting from the LED 70 is incident to the light entrance end so that light L3 transmits within the leaky optical fiber 10 and leaks gradually on the way of transmission.

The leaky optical fiber 10 leaks light L4 from a light leaking side along an elongated length of the leaky optical fiber 10.

The visible light responsive photocatalytic films 60 on the light guiding shelf 10 receives light L4 leaked from the leaky optical fiber 10 and the photocatalytic films 60 is excited by the light L4 so as to exhibit a photocatalytic decomposition activity.

(Leaky Optical Fiber)

A leaky optical fiber (i.e. side emitting light fiber) 30 used in the second embodiment is composed of an optical fiber having a light exit side face along a length of the optical fiber and first and/or second light entrance ends.

Two kinds of the leaky optical fibers may be selectively used in the invention, in which a first kind of the leaky optical fiber exits light from all peripheral portions on the side face along the length and a second kind of the leaky optical fiber exits light from a linear portion on the side face along the length.

The leaky optical fiber 80 preferably used in the invention is available from 3M, United States and SUMITOMO 3M LTD, Japan, in which 3M Light Fiber (trade mark, brand name) is a leaky plastic optical fiber to exit light from a side surface along a length of the fiber.

Various kinds of the leaky plastic optical fiber are available from 3M and Sumitomo 3M, for example, Product name LF90 (a core diameter of 9 mm and an outer diameter of 10 mm), Product name LF120 (core diameter: 12 mm/outer diameter: 14 mm), Product name LF120RH (core diameter: 12 mm/outer diameter: 14 mm) and Product name LF120HL (core diameter: 12 mm/outer diameter: 14 mm, with a white clad), according to Web catalogue.

In these leaky plastic optical fibers, a plastic core having acrylic resin is used which is suitable for use of visible light but not suitable for use of UV light.

These leaky plastic optical fibers are suitably used in the second embodiment of the invention, because a combination of the visible light responsive photocatalyst 80 and the visible light emitting LED/LEDs 70 are used in the second embodiment,

Other non-leaky plastic fibers may be used in the second embodiment by making a leaky processing, in which the leaky processing changes the non-leaky plastic fibers to leaky plastic fibers.

The non-leaky plastic fibers are available from Mitsubishi Rayon Co., Ltd. Japan as “ESKA” (trade mark) such as Product name CK-20 (diameter: 0.5 mm), Product name CK-40 (diameter: 1.0 mm), Product name CK-60 (diameter: 1.5 mm), Product name CK-80 (diameter: 2.0 mm), Product name CK-100 (diameter: 2.5 mm) and Product name CK-120 (diameter: 3.0 mm).

Another non-leaky plastic fibers are available from Asahi Chemical electronics Co. Japan, as “LUMINUS” (trade mark), such as Product name DB-500 (diameter: 0.5 mm), Product name DB-750 (diameter: 0.75 mm), Product name DB-1000 (diameter: 1.0 mm), Product name DB-1500 (diameter: 1.5 mm), Product name DB-2000 (diameter: 2.0 mm) and Product name DB-3000 (diameter: 3.0 mm),

A still another non-leaky plastic fibers are available from Hitachi Cable, Ltd. Japan, in which the non-leaky plastic fibers have an optical core made of silicone resin such as Product name HLG-Hd/D (core diameter: 5.0 mm to 9.0 mm, outer diameter: 6.0 mm to 10.5 mm, Product name HLG-Sd/D (core diameter: 5.0 mm to 9.0 mm, outer diameter: 6.0 mm to 10.5 mm.

The leaky processing for changing the non-leaky plastic optical fibers to the leaky plastic optical fibers are made such as by hot stamping, blasting, laser removing so that an optical clad is partially removed along a length of the non-leaky plastic optical fibers so as to expose an optical core.

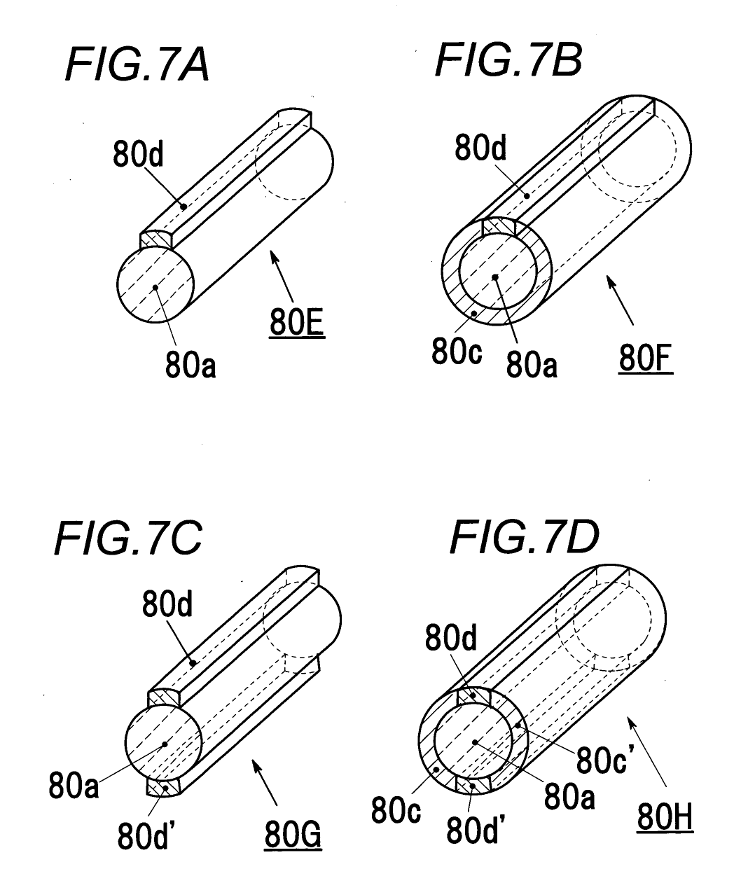

Referring to (FIG. 6A, FIG. 6B, FIG. 6C, FIG. 6D) and (FIG. 7A, FIG. 7B, FIG. 7C, FIG. 7D), several structures of the leaky optical fiber 80 are explained.

A leaky optical fiber 80A shown in FIG. 6A is made in such a manner that at first, a non-leaky optical fiber composed of a core 80a having a first refractive index and a clad 80b having a second refractive index smaller than the first refractive index and a clad 80b is prepared beforehand, next an upper portion of the clad 80b is removed along a length of the optical fiber 80A by the leaky processing method so that a core exposed portion 80a′ is formed, from which light transmitted within the optical fiber 80A is leaked to outside.

A leaky optical fiber 80B shown in FIG. 6B is made such that a transparent resin film 80c is coated on the core exposed portion 80a′ of the leaky optical fiber 80A shown in FIG. 6A, in which the transparent resin film 80c has a third refractive index equal to or higher than the first refractive index of the core 80b.

The transparent resin film 80c preferably contains known white pigments or light diffusing beads made of glass or polymer material having a refractive index different from the transparent resin film 80c, so that the transparent resin film 80c has a light diffusing function.

The leaky optical fibers 80A (see FIG. 6B) and 80B (see FIG. 6B) leak light which is transmitted within the core 80a from the upper portion 80a′ and 80c to outside along the length of the fiber 80A and 80B.

As shown in FIG. 6C, a leaky optical fiber 80C is a modification of the leaky optical fiber 80A (see FIG. 6A), in which the leaky optical fiber 80C has an upper exposed core portion 80a′ and a lower exposed core portion 80a″, and light transmitted within core 80a is leaked from the upper and lower exposed core portions 80a′ and 80a″.

As shown in FIG. 6D, a leaky optical fiber 80D is a modification of the leaky optical fibers 80B (see FIG. 6B) and 80C (see FIG. 6C), in which the leaky optical fiber 80D has upper and lower exposed core portions 80a′ and 80a″ (see FIG. 6C) and upper and lower transparent films 80c (see FIG. 6B) and 80c′, and light transmitted within core 80a is leaked from the upper and lower transparent films 80c and 80c′.

As shown in FIG. 7A, a leaky optical fiber 80E is composed of a clad-less optical fiber (core) 80a and an upper transparent linear film 80d formed on the core 80a along a length of the clad-less optical fiber (core) 80a, in which a refractive index of the upper transparent linear film 80d is higher than the core 80a so as to enhance a leakage of light.

The transparent linear film 80d preferably contains known white pigments or light diffusing beads made of glass or polymer material having a refractive index different from the transparent linear film 80d, so that the transparent linear film 80d has a light diffusing function.

As shown in FIG. 7C, a leaky optical fiber 80G is composed of a clad-less optical fiber (core) 80a and upper and lower transparent linear films 80d and 80d′ formed on the core 80a along a length of the clad-less optical fiber (core) 80a, in which a refractive index of the upper and lower transparent linear films 80d and 80d′ is higher than the core 80a so as to enhance a leakage of light.

As shown in FIG. 7B, a leaky optical fiber 80F is composed of an optical fiber having a core 80a with a higher refractive index and a clad 80c with a lower refractive index formed on the core 80a except for an upper exposed linear portion, in which an upper linear transparent film 80d is formed on the upper exposed linear portion of the core 80a.

The upper linear transparent film 80d has a refractive index equal to or higher than the core 80a and the clad 80c, therefore light transmitted within the core 80a is leaked from the upper linear transparent film 80d along a length of the leaky optical fiber 80E.

As shown in FIG. 7D, a leaky optical fiber 80H is composed of an optical fiber having a core 80a with a higher refractive index and divided clads 80c/80c′ with a lower refractive index formed on the core 80a except for upper and lower exposed linear portions, in which upper and lower linear transparent film 80d and 80d′ are formed on the upper and lower exposed linear portion of the core 80a.

The upper and lower linear transparent films 80d and 80d′ have a refractive index equal to or higher than the core 80a and the clads and the clad 80c and 80c′, therefore light transmitted within the core 80a is leaked from the upper and lower linear transparent films 80d and 80d′ along a length of the leaky optical fiber 80E.

Referring to FIG. 4, FIG. 5A and FIG. 5B again, two LEDs emitting visible light including a blue wavelength range are mounted on the printed circuit board 72, in which the printed circuit board 72 may be fixed on the wall 100a (see FIG. 5A).

The leaky optical fiber 80 is located in the light guide shelf plate 10 so that two end faces 80-1 and 80-2 of the leaky optical fiber 80 is positioned near the side face 10c of the light guide shelf plate 10.

The two end faces 80-1 and 80-2 of the leaky optical fiber 80 (and optionally the side face 10c) are adjacently positioned to face two light emitting windows 71 of the two LEDs 70 with a gap between the two end faces 80-1/80-2 and the two LEDs 70.

Alternatively, the LED mounted circuit board (72 and 80) may be located in any place in a refrigerator box far from the light guide member/leaky optical fiber (10 and 80), if at least one optical fiber for light transmission (not shown in Figures) is interposed between the LEDs 72 and the leaky optical fiber 80.

As shown in FIG. 4, FIG. 5A and FIG. 5B, visible light responsive photocatalytic films 60 (60a, 60b, 60c, 60d) containing or consisting of the visible light response type photocatalyst may be formed partially or entirely on the front and rear surfaces 10a, 10b and the three sides 10a, 10b, 10d, except for the side face 10c which is the light entrance portion to receive light from the visible color LED 70.

As shown in FIG. 4, FIG. 5A and FIG. 5B, visible light L1 to emit from the window (or lens) 71 of the LED/LEDs 70 is incident to the light entrance end/ends of the leaky optical fiber 80, the visible light L3 transmits within the leaky optical fiber 80 and the visible light L1 also leaks from the leaky optical fiber 80 to the light guide shelf plate 10 through the transparent adhesive 81.

Visible light L4 leaked from the leaky optical fiber 80 advances to expand within the light guide member 10 toward the visible light responsive photocatalytic films 60 (60a, 60b, 60c, 60d) formed partially or entirely on the light guide member 10, in which the visible light responsive photocatalytic films 60 (60a, 60b, 60c, 60d) absorb the visible light L4 and the photocatalytic films 60 are excited to indicate a photocatalytic activity.

Therefore, dirt or odor organic components such as bacteria, mold, dirt ingredients of foodstuff which are adhered on or contacted with the photocatalyst films 60 (60a, 60b, 60c, 60d) on the light guide shelf 10 are decomposed by the photocatalytic decomposition activity.

Thereby, the light guide shelf 10 and also air circulating in the room of the refrigerator are kept clean, due to the photocatalytic decomposition activity. showing sterilization, disinfection, antibacterial and deodorizing properties.

### A THIRD EMBODIMENT OF THE INVENTION

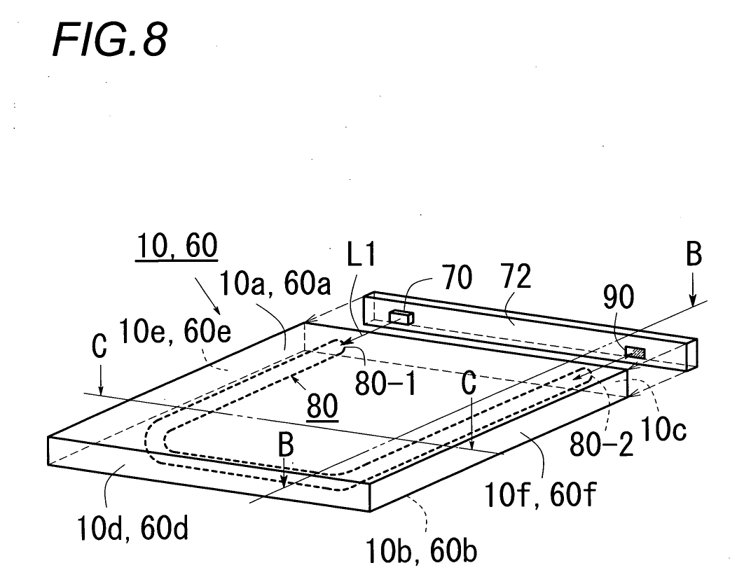

Referring to FIG. 8, a third embodiment is explained below.

Because the third embodiment is a modification of the second embodiment, an explanation of the same portion as the second embodiment is omitted as much as possible.

As shown in FIG. 8, visible light responsive photocatalytic films 60 (60a, 60b, 60c, 60d) containing or consisting of a visible light response type photocatalyst may be formed partially or entirely on front and rear surfaces 10a, 10b and three sides 10a, 10b, 10d of a light guide shelf plate 10, except for a side face 10c which is a light entrance portion to receive light from the visible color LED 70.

In the third embodiment, a leaky optical fiber 80 is placed in or adjacent to the light guide shelf 10 similarly to the second embodiment.

The light guide shelf 10 may be provided with an “U” shaped groove in the rear surface 10b and the leaky optical fiber 80 bent to the “U” shape is placed in the groove.

A pair of end faces 80-1 and 80-2 of the leaky optical fiber 80 is positioned near the side face 10c of the he leaky optical fiber 80.

In the third embodiment of the invention, the printed circuit board 72 is provided with a LED 70 and a reflector 90, in which the LED 70 is positioned to face one end face 80-1 of the leaky optical fiber 80 and the reflector 90 is positioned to face another end face 80-2 of the leaky optical fiber 80.

Light from the LED 70 is incident to the one end face 80-1, the light transmits within the leaky optical fiber 80 with “U” shape toward the another end face 80-2 and the light advanced to the another end face 80-2 is reflected back toward the one end face 80-1.

Light leaked from the leaky optical fiber 80 on the way of transmission enters into the visible light responsive photocatalytic films 60 (60a, 60b, 60c, 60d) through the light guide shelf plate 10.

Instead, the reflector or reflecting film 90 may be positioned on the another end face 80-2 of the leaky optical fiber 80.

### A FOURTH EMBODIMENT OF THE INVENTION

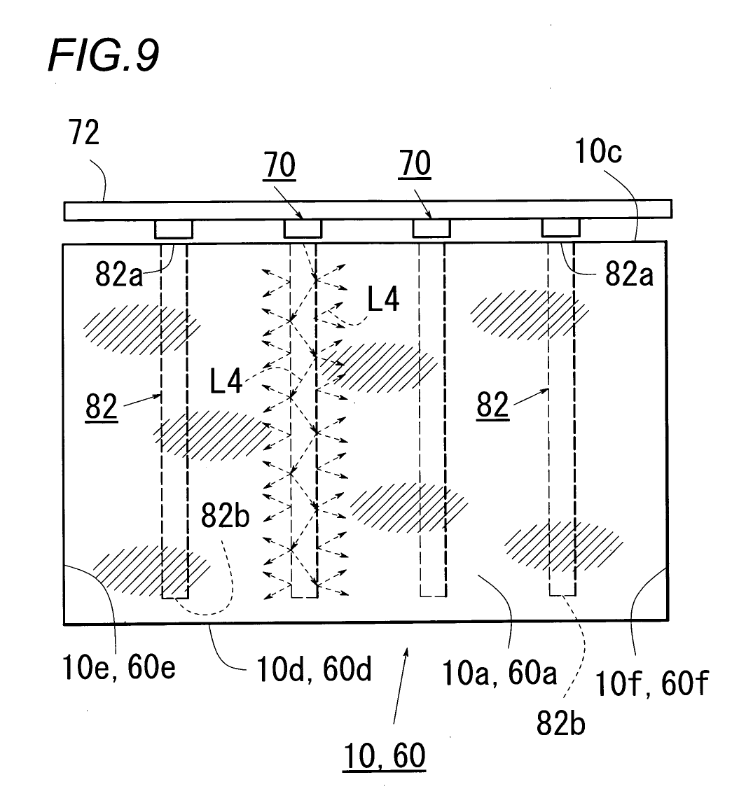

Referring to FIG. 9, a fourth embodiment of the invention is described as follows.

As shown in FIG. 9, visible light responsive photocatalytic films 60 (60a, 60b, 60c, 60d) may be formed partially or entirely on a front surface 10a, a rear surface opposed to the front surfaces 10a and three sides 10d, 10e, 10f of a light guide shelf plate 10, except for a side face 10c of the light guide shelf plate 10 and end faces 82a of the leaky optical fiber 80, which are light entrance portions to receive light from a plurality of visible color LEDs 70.

A plurality of leaky optical fibers 82 having an “I”-like linear shape is positioned in a plurality of linear grooves (linear slits) formed in the rear surface of the light guide shelf plate 10, the linear leaky optical fibers 82 (and the linear grooves) are arranged in parallel.

The visible color LEDs 70 are mounted on a printed circuit board 72, in which the LED mounted printed circuit board (70 and 72) is positioned adjacent to the light entrance portions of the side face 10c and the end faces 82a.

Light L4 from the LEDs 70 is incident to the end faces 82a, the light L4 transmits within the leaky optical fibers 82 toward other end faces 82b and the light L4 leaked from the leaky optical fibers 82 on the way of transmission enters into the visible light responsive photocatalytic films 60 (e.g. 60a, 60d, 60e, 60f) through the light guide shelf plate 10.

### A FIFTH EMBODIMENT OF THE INVENTION

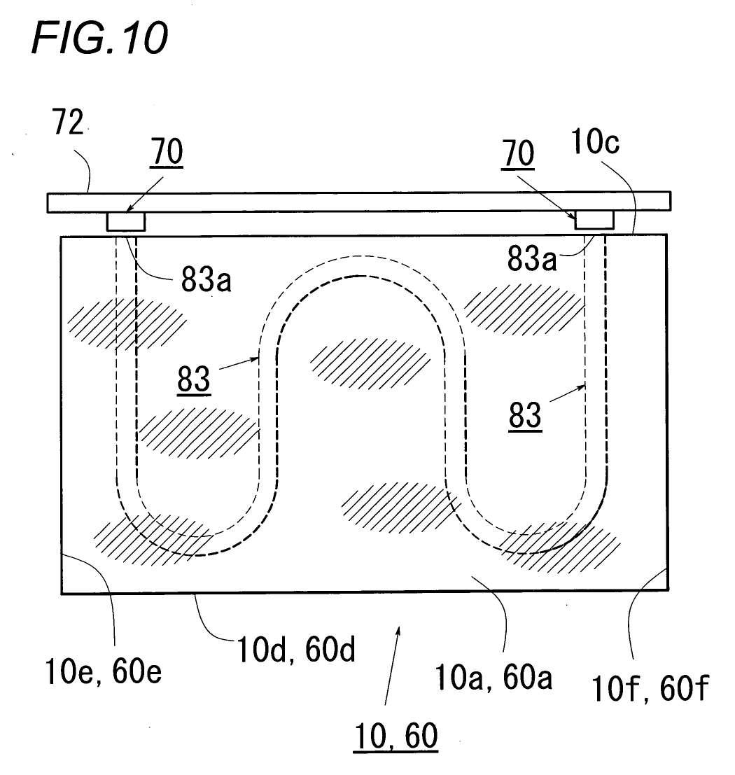

Referring to FIG. 10, a fifth embodiment of the invention is described below.

As shown in FIG. 10, visible light responsive photocatalytic films 60 (60a, 60b, 60c, 60d) may be formed partially or entirely on a light guide shelf plate 10a (a front surface 10a, a rear surface opposed to the front surfaces 10a and three sides 10d, 10e, 10f), except for a side face 10c of the light guide shelf plate 10 and end faces 83a of the leaky optical fiber 83, which are light entrance portions to receive light from two visible color LEDs 70.

A leaky optical fiber 83 in this embodiment of the invention has a meandered shape such as “W” or “M” shape as a whole and the meandered leaky optical fiber 83 is positioned in a meandered shaped groove formed in the rear surface of the light guide shelf plate 10.

The visible color LEDs 70 are mounted on a printed circuit board 72, in which the LED mounted printed circuit board (70 and 72) is positioned adjacent to the light entrance portions of the side face 10c and two end faces 83a of the leaky optical fiber 83.

Light from the LEDs 70 is incident to the end faces 83a, the light transmits within the leaky optical fibers 83, the light leaked from the leaky optical fibers 83 on the way of transmission and enters into the visible light responsive photocatalytic films 60 (e.g. 60a, 60d, 60e, 60f) through the light guide shelf plate 10.

White color emitting LED can be used for visible light emitting element/elements in all the embodiments of the invention, in which the white color emitting LED/may be composed of a LED having near UV or blue emitting LED and a wavelength converting phosphor to emit white color consisting of blue, green and red color, instead a combination of three separated LEDs having a blue emitting LED, a green emitting LED and a red emitting LED can be used.

Some volume of blue light from the LED is absorbed in the photocatalyst to excite it, and three colors of light consisting of green light, red light and the rest of the blue light from the LED without absorbing in the photocatalyst can exit from the light guide member so as to illuminate a store room of a refrigerator.

In some embodiments described hereinbefore, the light guide member and/or the leaky optical fiber are preferably composed of resin material.

In some embodiments described hereinbefore, the light guide member and/or the leaky optical fiber may contain a plurality of diffusing particles to enhance a leaking capability.

In some embodiments described hereinbefore, the light guide member may be eliminated, if the photocatalyst is disposed on, or adjacent to the leaky optical fiber, such that a refrigerator having photocatalyst, comprises: at least one leaky optical fiber having a light leaking side surface and at least one light entrance end; a photocatalyst composed of visible light responsive photocatalytic material, disposed on or adjacent to the light leaking side surface; and at least one visible light emitting type light emitting element, for emitting visible light which is directed or incident to the at least one light entrance end.

Although illustrative embodiments of the present invention have been described referring to the accompanying drawings, it is to be understood that the present invention is not limited to those embodiments and that various changes, modifications or equivalents may be made in the present invention by those skilled in the art without departing from the spirit or the scope of the present invention and the appended claims.

What is claimed is:

1. A refrigerator having photocatalyst, comprising:
a photocatalytic light guide member, composed of a light guide member and a photocatalyst;
the light guide member having a light entrance portion and a light leaking portion;
the photocatalyst being composed of visible light responsive photocatalytic material, disposed on or adjacent to the light leaking portion;
at least one visible light emitting type light emitting element, for emitting visible light which is directed or incident to the light entrance portion; and
wherein the visible light responsive photocatalytic material is excited by visible light which is leaked from the light leaking portion.

2. The refrigerator according to claim 1, wherein the light guide member comprises at least one shelf plate, a top plate, a back plate, a bottom plate, and/or at least one side plate.

3. The refrigerator according to claim 1: wherein the light guide member comprises a light transmissive plate or panel having opposed surfaces and opposed sides; wherein a photocatalytic film contains or consists of the photocatalyst, which is disposed partially or entirely on at least one of the opposed surfaces; and wherein the at least one visible light emitting type light emitting element is disposed to face at least one of the opposed sides.

4. The refrigerator according to claim 1: wherein the light guide member comprises a leaky optical fiber having a light leaking side surface and a light entrance end.

5. The refrigerator according to claim 1: wherein a photocatalytic film comprises a plurality of photocatalyst particles having the photocatalyst and a transparent binder containing the photocatalyst particles.

6. The refrigerator according to claim 1: wherein a photocatalytic film comprises a plurality of photocatalyst particles having the photocatalyst, a plurality of light diffusing particles and a transparent binder containing the photocatalyst particles and the light diffusing particles.

7. The refrigerator according to claim 1: wherein the at least one visible light emitting type light emitting element comprises at least one light emitting diode (LED) to emit blue light and/or white light.

8. The refrigerator according to claim 1: wherein the at least one visible light emitting type light emitting element comprises at least one light emitting diode (LED) to emit at least blue light; and wherein the photocatalyst is excited by blue light from the LED.

9. The refrigerator according to claim 1: wherein the light guide member comprises a resin material

10. A refrigerator having photocatalyst, comprising:
a photocatalytic light guide member, composed of a light guide member and a photocatalyst;
at least one leaky optical fiber having a light leaking side surface and a light entrance end, disposed in/on or adjacent to the light guide member;
the photocatalyst being composed of visible light responsive photocatalytic material, disposed on or adjacent to the light guide member; and
at least one visible light emitting type light emitting element, for emitting visible light which is directed or incident to the light entrance end.

11. The refrigerator according to claim 10: wherein the visible light responsive photocatalytic material is excited by visible light which leaked from the leaky optical fiber through the light guide member.

12. The refrigerator according to claim 10, wherein the light guide member comprises at least one shelf plate, a top plate, a back plate, a bottom plate, and/or at least one side plate.

13. The refrigerator according to claim 10: wherein the light guide member comprises a light transmissive plate or panel having opposed surfaces and opposed sides; wherein a photocatalytic film contains or consists of the photocatalyst, which is disposed partially or entirely on at least one of the opposed surfaces; and wherein the at least one visible light emitting type light emitting element is disposed to face at least one of the opposed sides.

14. The refrigerator according to claim 10: wherein a photocatalytic film comprises a plurality of photocatalyst particles having the photocatalyst and a transparent binder containing the photocatalyst particles.

15. The refrigerator according to claim 10: wherein a photocatalytic film comprises a plurality of photocatalyst particles having the photocatalyst, a plurality of light diffusing particles and a transparent binder containing the photocatalyst particles and the light diffusing particles.

16. The refrigerator according to claim 10: wherein the at least one visible light emitting type light emitting element comprises at least one light emitting diode (LED) to emit blue light and/or white light.

17. The refrigerator according to claim 10: wherein the at least one visible light emitting type light emitting element comprises at least one light emitting diode (LED) to emit at least blue light; and wherein the photocatalyst is excited by blue light from the LED.

18. The refrigerator according to claim 10: wherein the light guide member and/or the leaky optical fiber comprises a resin material.

19. The refrigerator according to claim 10: wherein the light guide member and/or the leaky optical fiber contain a plurality of diffusing particles.

20. A refrigerator having photocatalyst, comprising:
at least one leaky optical fiber having a light leaking side surface and at least one light entrance end;
a photocatalyst composed of visible light responsive photocatalytic material, disposed on or adjacent to the light leaking side surface; and
at least one visible light emitting type light emitting element, for emitting visible light which is directed or incident to the at least one light entrance end.
